(19) United States
(12) Patent Application Publication
(10) Pub. No.: US 2014/0045057 A1
(43) Pub. Date: Feb. 13, 2014

(54) NON-AQUEOUS ELECTROLYTE SECONDARY BATTERY

(71) Applicant: Sanyo Electric Co., Ltd., Moriguchi City (JP)

(72) Inventors: Shingo Tode, Kasai City (JP); Keisuke Minami, Kanzaki-gun (JP); Toyoki Fujihara, Kanzaki-gun (JP); Toshiyuki Nohma, Kobe City (JP)

(21) Appl. No.: 13/943,016

(22) Filed: Jul. 16, 2013

(30) Foreign Application Priority Data
Aug. 9, 2012 (JP) 2012-177188

(51) Int. Cl. H01M 10/0561

(52) U.S. Cl. CPC H01M 10/0561
USPC 429/199; 429/188

(57) ABSTRACT

To provide with high productivity a non-aqueous electrolyte secondary battery having high capacity.

The present invention is a non-aqueous electrolyte secondary battery provided with an electrode assembly and a non-aqueous electrolyte including a non-aqueous solvent, the electrode assembly including a positive electrode and a negative electrode. In the positive electrode, a positive electrode active material layer is formed on a positive electrode core. In the non-aqueous electrolyte secondary battery, the non-aqueous solvent includes 30 to 70 vol % ethylene carbonate at 25° C. and 1 atm, the non-aqueous electrolyte includes lithium bis(oxalato)borate, and the packing density of the positive electrode active material layer is from 2.0 to 2.8 g/ml.

### CROSS-REFERENCE TO RELATED APPLICATIONS

This application claims the benefit of Japanese Patent Application No. 2012-177188 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the battery characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrodes have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current. As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

Patent Document 1 Published Unexamined Patent Application No. 2010-086780

The technology disclosed in Patent Document 1 is a rectangular secondary battery having a first electrode core and a second electrode core on both ends in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved output characteristics as well as improved durability, such as storage characteristics and cycle characteristics. However, these points are not considered in Patent Document 1.

In view of this situation, an object of the present invention is to provide with high productivity a non-aqueous electrolyte secondary battery having a high capacity and superior cycle characteristics.

### Means of Solving the Problem

In order to solve this problem, the present invention is a non-aqueous electrolyte secondary battery provided with an electrode assembly and a non-aqueous electrolyte including a non-aqueous solvent, the electrode assembly including a positive electrode and a negative electrode. In the positive electrode, a positive electrode active material layer is formed on a positive electrode core. In the non-aqueous electrolyte secondary battery, the non-aqueous solvent includes 30 to 70 vol % ethylene carbonate at 25° C. and 1 atm, the non-aqueous electrolyte includes lithium bis(oxalato)borate, and the packing density of the positive electrode active material layer is from 2.0 to 2.8 g/ml.

In this configuration, the non-aqueous solvent contains 30 vol % or more ethylene carbonate. This improves the discharge characteristics. The non-aqueous electrolyte also contains lithium bis(oxalato)borate (LiB(C₂O₄)₂). This improves the cycle characteristics.

The ethylene carbonate and lithium bis(oxalato)borate both increase the viscosity of the non-aqueous solvent and reduce the permeability in the positive electrode. In the present invention, however, the positive electrode combined with the non-aqueous electrolyte has a positive electrode active material layer packing density of 2.8 g/ml which ensures that there are sufficient gaps in the positive electrode active material layer. As a result, the permeability is not poor even when the non-aqueous solvent has a high viscosity.

When too much ethylene carbonate is added, the viscosity of the non-aqueous electrolyte is too high and the permeability is poor even when used with the positive electrode described above. Therefore, the upper limit on the amount of ethylene carbonate added is 70 vol %.

When the packing density of the positive electrode active material layer is too low, the battery capacity tends to decline. Therefore, the lower limit on the packing density of the positive electrode active material layer is 2.0 g/ml.

The packing density of the positive electrode active material layer was determined in the following manner. The positive electrode was cut to 10 cm², and the mass A (g) of the cut 10 cm² positive electrode and the thickness C (cm) of the positive electrode were measured. Next, the mass B (g) of the 10 cm² core and the thickness D (cm) of the core were measured. Finally, the packing density was determined using the following equation:

Packing Density (g/ml)=(A−B)/[(C−D)×10 cm²]

When the non-aqueous electrolyte contains too little lithium bis(oxalato)borate, the effect is insufficient. When too much lithium bis(oxalato)borate is added, the upper limit on effectiveness is exceeded and the additional amount is not cost effective. Therefore, the amount of lithium bis(oxalato)borate added is preferably from 0.05 to 0.20 mol/L.

The range for the amount of lithium bis(oxalato)borate in the non-aqueous electrolyte is determined based on the non-aqueous electrolyte in the non-aqueous electrolyte secondary battery after assembly and before the first charge. The range is determined in this manner because the amount gradually decreases as the non-aqueous electrolyte battery containing lithium bis(oxalato)borate is charged. This is believed to be caused by the consumption of some of the lithium bis(oxalato)borate in the formation of film on the negative electrode during charging.

In this configuration, the non-aqueous electrolyte can also contain lithium difluorophosphate.

When the non-aqueous electrolyte contains lithium difluorophosphate (LiPO₂F₂), the low temperature output characteristics are increased.

When too little lithium difluorophosphate is added, the effect is insufficient. When too much lithium difluorophosphate is added, the upper limit on effectiveness is exceeded and the additional amount is not cost effective. Therefore, the amount of lithium difluorophosphate added is preferably from 0.01 to 0.10 mol/L.

The range for the amount of lithium difluorophosphate in the non-aqueous electrolyte is determined based on the non-aqueous electrolyte in the non-aqueous electrolyte secondary battery after assembly and before the first charge. The range is determined in this manner because the amount gradually decreases as the non-aqueous electrolyte battery containing lithium difluorophosphate is charged. This is believed to be caused by the consumption of some of the lithium difluorophosphate in the formation of film on the negative electrode during charging.

When the battery capacity increases, the amount of positive electrode active material used increases proportionally, and the permeability of the non-aqueous electrolyte in the positive electrode tends to decrease. However, the configuration of the present invention can increase the permeability of the non-aqueous electrolyte in the positive electrode. As a result, the present invention is very effective when applied to a non-aqueous electrolyte secondary battery with a battery capacity of 21 Ah or higher.

In the present invention, the battery capacity is the discharge capacity (initial capacity) when the battery has been charged to a battery voltage of 4.1 V using 21 A of constant current, charged for 1.5 hours at a constant voltage of 4.1 V, and then discharged after charging to a battery voltage of 2.5 V at a constant current of 21 A. The charging and discharging was performed entirely at 25° C.

In this configuration, the positive electrode can have a positive electrode core exposing portion in which the positive electrode active material layer is not formed and in which the positive electrode core is exposed, and a positive electrode protecting layer containing insulating inorganic particles and conductive inorganic particles can be formed in a region of the positive electrode core exposing portion contiguous with the positive electrode active material layer.

When a positive electrode protecting layer containing insulating inorganic particles and conductive inorganic particles is formed in a region of the positive electrode core exposing portion contiguous with the positive electrode active material layer, the permeability of the non-aqueous electrolyte in the positive electrode active material layer is further increased by the positive electrode protecting layer. Also, the positive electrode protecting layer contains insulating inorganic particles and conductive inorganic particles, and has lower conductivity than the positive electrode core. As a result, weak internal short-circuit current continues to flow when there is an internal short circuit due to contamination of the positive electrode protecting layer and the negative electrode core by conductive impurities. This can transition the battery to a safe state.

The conductivity of the positive electrode protecting layer can be controlled by adjusting the mixing ratio of the conductive inorganic particles and the insulating inorganic particles. Preferably, the positive electrode protecting layer includes a binder for binding the particles to each other and for binding the particles to the positive electrode core.

### Effect of the Invention

The present invention is able to provide with high productivity a non-aqueous electrolyte secondary battery having a high capacity and superior cycle characteristics.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIG. 3a-3b are plan views showing the positive and negative electrodes used in a non-aqueous electrolyte secondary battery according to the first embodiment of the present invention.

FIG. 4a-4b are plan views showing the positive and negative electrodes used in a non-aqueous electrolyte secondary battery according to the second embodiment of the present invention.

### DETAILED DESCRIPTION

### Embodiment 1

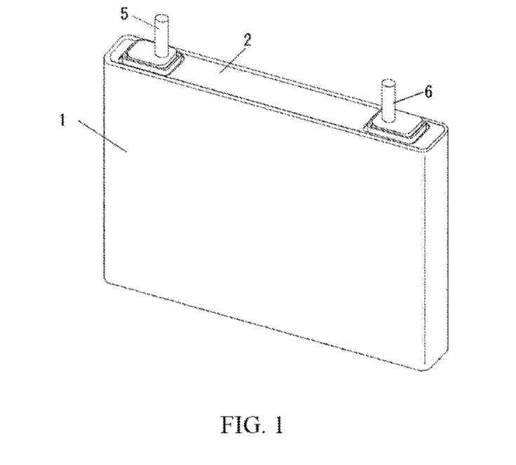

The following is an explanation with reference to the drawings of the battery of the present invention as applied to a lithium ion secondary battery. FIG. 1 is a perspective view of a non-aqueous electrolyte secondary battery according to the present invention,

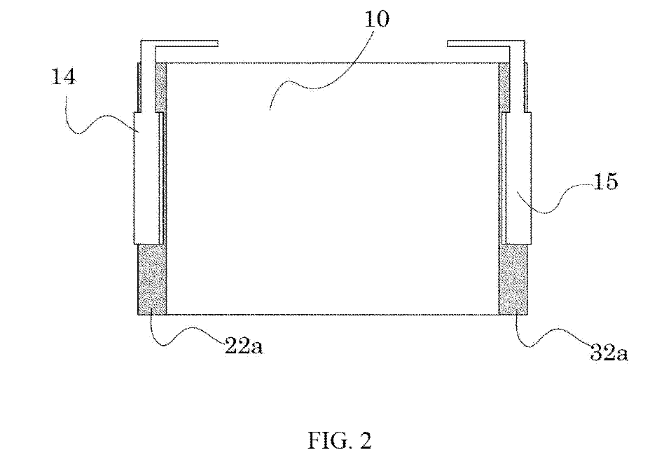

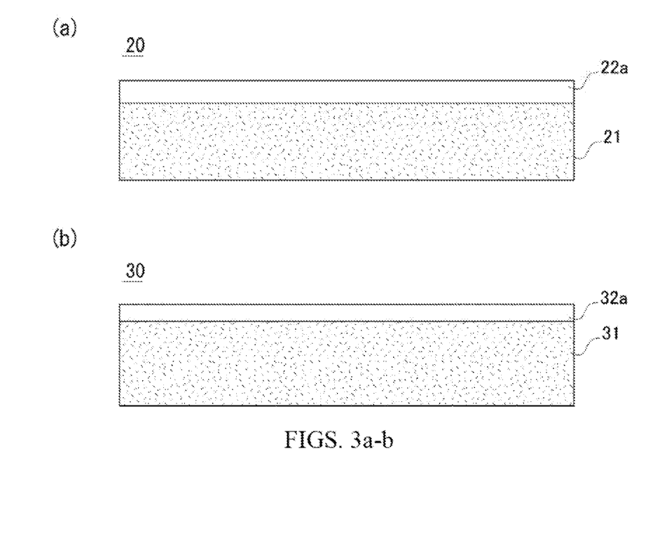

FIG. 2 is a diagram showing the electrode assembly used in a non-aqueous electrolyte secondary battery according to the present invention, and FIG. 3 is a plan view showing the positive and negative electrodes used in a non-aqueous electrolyte secondary battery according to the first embodiment of the present invention.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3, the positive electrode 20 in the electrode assembly has a positive electrode core exposing portion 22a exposed on at least one end in the longitudinal direction of the band-shaped positive electrode core, and a positive electrode active material layer 21 formed on the positive electrode core. The negative electrode 30 has a first negative core exposing portion 32a exposed on at least one end in the longitudinal direction of the band-shaped negative electrode core, and a negative electrode active material layer 31 formed on the negative electrode core.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

This electrode assembly 10 is housed inside the outer can 1 along with the non-aqueous electrolyte, and the positive electrode collector 14 and the negative electrode collector 15 are connected electrically to external terminals 5, 6 protruding from the sealing plate 2 while being insulated from the sealing plate 2 to extract current.

The non-aqueous electrolyte includes a non-aqueous solvent and an electrolyte salt dissolved in this solvent. The non-aqueous solvent includes 30 to 70 vol % ethylene carbonate at 25° C. and 1 atm, and the non-aqueous electrolyte includes lithium bis(oxalato)borate as an electrolyte salt. The ethylene carbonate improves the discharge characteristics, and the lithium bis(oxalato)borate improves the cycle characteristics.

The packing density of the positive electrode active material layer is from 2.0 to 2.8 g/ml, and ensures sufficient gaps in the positive electrode active material layer. The 30 vol % or more ethylene carbonate and the lithium bis(oxalato)borate increase the viscosity of the non-aqueous electrolyte, but a positive electrode active material layer packing density of 2.0 to 2.8 g/ml keeps the permeability of the positive electrode active material layer to the non-aqueous electrolyte from deteriorating.

Because easy permeability of the non-aqueous electrolyte is significantly reduced in a battery having a battery capacity of 21 Ah or more, the present invention can be advantageously applied to these batteries.

The following is an explanation of the method used to manufacture a lithium ion secondary battery with this configuration.

### Preparation of the Positive Electrode

The positive electrode active material slurry is prepared by mixing together a lithium-containing nickel-cobalt-manganese composite oxide (LiNi_{0.35}Co_{0.35}Mn_{0.3}O₂) serving as the positive electrode active material, a carbon-based charging agent such as acetylene black or graphite, and a binder such as polyvinylidene fluoride (PVDF) at a mass ratio of 88:9:3, and then dissolving and mixing the mixture in N-methyl-2-pyrrolidone serving as the organic solvent.

The positive electrode active material slurry is applied to a uniform thickness on both sides of band-shaped aluminum foil serving as the positive electrode core 22 (thickness: 20 μm) using a die coater or doctoring blade. However, the slurry is not applied on the ends in the longitudinal direction of the positive electrode core 22 (the end in the same direction on both sides) to expose the core and form the positive electrode core exposing portion 22a.

The electrode is passed through a dryer to remove the organic solvent and create a dry electrode. The dry electrode is then rolled using a roll press. Afterwards, it is cut to a predetermined size to complete the positive electrode 20.

### Preparation of Negative Electrode

The negative electrode active material slurry is prepared by mixing together graphite serving as the negative electrode active material, styrene butadiene rubber serving as the binder, and carboxymethyl cellulose serving as the thickener at a mass ratio of 98:1:1, and then adding the appropriate amount of water.

The negative electrode active material slurry is applied to a uniform thickness on both sides of band-shaped copper foil serving as the negative electrode core 32 (thickness: 12 μm) using a die coater or doctoring blade. However, the slurry is not applied on the ends in the longitudinal direction of the negative electrode core 32 to expose the core and form the negative electrode core exposing portion 32a.

The electrode is passed through a dryer to remove the water and create a dry electrode. The dry electrode is then rolled using a roll press. Afterwards, it is cut to a predetermined size to complete the negative electrode 30.

### Preparation of Electrode Assembly

As shown in FIG. 3, the positive electrode, the negative electrode and a polyethylene microporous membrane separator were laid on top of each other so that the positive electrode core exposing portion 22a and the negative electrode core exposing portion 32a protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press.

### Connection of the Collector to the Sealing Plate

An aluminum positive electrode collector 14 and a copper negative electrode collector 15 with two protrusions (not shown) on the same surface were prepared, and two aluminum positive electrode collector receiving components (not shown) and two copper negative electrode collector receiving components (not shown) with one protrusion on one surface were also prepared. Insulating tape was applied to enclose the protrusions of the positive electrode collector 14, negative electrode collector 15, positive electrode collector receiving components and negative electrode collector receiving components.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. The positive electrode collector 14 was positioned on top of the insulating component on the inside surface of the sealing plate 2 so that the through-hole in the sealing plate 2 was aligned with the through-hole (not shown) in the collector. Afterwards, the inserted portion of a negative electrode terminal 5 having a flange portion (not shown) and an inserted portion (not shown) was inserted from outside the battery into the through-hole in the sealing plate 2 and the through-hole of the collector. The diameter of the lower end of the inserted portion (inside the battery) is then widened, and the positive electrode collector 14 and the positive electrode terminal 5 were caulked to the sealing plate 2.

The negative electrode collector 15 and the negative electrode terminal 6 were caulked to the sealing plate 2 in the same way on the negative electrode side. In this operation, the various components were integrated, and the positive and negative electrode collector 14, 15 and the positive and negative electrode terminals 5, 6 were connected conductively. In this structure, the positive and negative electrode terminals 5, 6 protruded from the sealing plate 2 while remaining insulated from the sealing plate 2.

### Mounting of the Collector

The positive electrode collector 14 was arranged on the side of the flat electrode assembly with the core exposing portion of the positive electrode 11 so that the protrusion was on the side with the positive electrode core exposing portion 22a. One of the positive electrode collector receiving components is brought into contact with the positive electrode core exposing portion 22a so that the protrusion on the positive electrode collector receiving component is on the positive electrode core exposing portion 22a side, and so that one of the protrusions on the positive electrode collector 14 is facing the protrusion on the positive electrode collector receiving component. Next, a pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded to the positive electrode core exposing portion 22a.

Afterwards, the other positive electrode collector receiving portion is brought into contact with the positive electrode core exposing portion 22a so that the protrusion on the positive electrode collector receiving portion is on the positive electrode core exposing portion 22a side, and so that the other protrusion on the positive electrode collector 14 is facing the protrusion on the positive electrode collector receiving component. Next, the pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded a second time to the positive electrode core exposing portion 22a.

In the case of the negative electrode 12, the negative electrode collector 15 and the negative electrode collector receiving components are resistance-welded to the first negative electrode core exposing portion 32a in the same way.

### Preparation of Non-Aqueous Electrolyte

Ethylene carbonate (EC) and ethylene methyl carbonate (EMC) are mixed together at a volume ratio of 3:7 (1 atm, 25° C.), and a LiPF₆ electrolyte salt is dissolved in the resulting non-aqueous solvent at a ratio of 1 mol/L to complete the base electrolyte solution. To the resulting base electrolyte solution are added 0.3 mass % vinylene carbonate, and 0.1 mol/L lithium bis(oxalato)borate (LiB(C₂O₄)₂). The result is the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the sealing plate 2, and the non-aqueous electrolyte hole was sealed.

### Embodiment 2

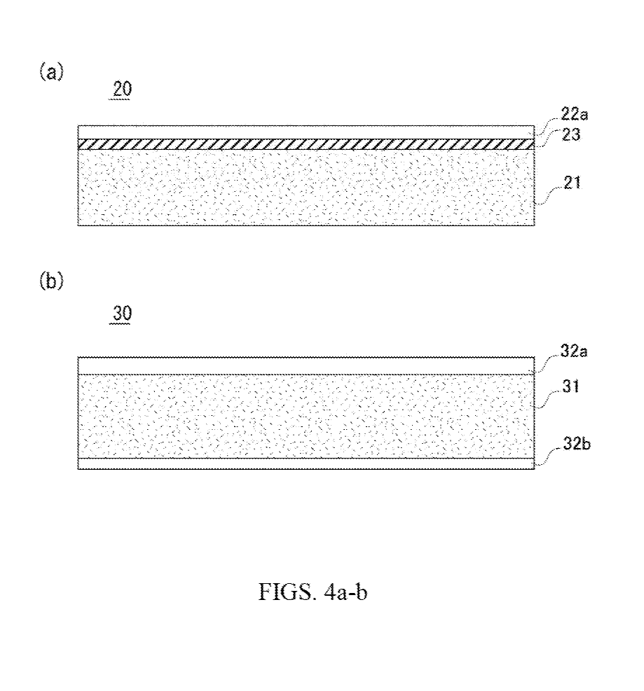

FIG. 4 is a plan view showing the positive and negative electrodes used in a non-aqueous electrolyte secondary battery according to the second embodiment of the present invention. In the present embodiment, as shown in FIG. 4, the positive electrode 20 is configured so the positive electrode protecting layer 23 is provided in the positive electrode core exposing portion 22a near the positive electrode active material layer 21 and contiguous with the positive electrode active material layer 21, and the negative electrode 30 has negative electrode core exposing portions 32a, 32b exposing both ends of the band-shaped negative electrode core in the longitudinal direction, and a negative electrode active material layer 31 formed on the negative electrode core. Otherwise, the configuration is identical to that in the first embodiment.

Except for the points of difference, further explanation of the configuration has been omitted.

From the standpoint of improving productivity, a plurality of positive electrodes can be obtained by using a single electrode core that is wider than an electrode to simultaneously form a plurality of active material layers. The electrodes are then cut to the predetermined length and width. In the case of a positive electrode using a lithium-containing transition metal composite oxide as the positive electrode active material, the active material does not come off the positive electrode active material layer 21 even when the positive electrode active material layer 21 is cut. Therefore, such a cutting method can be used.

On the other hand, in the case of a negative electrode using a carbon material as the negative electrode active material, the active material tends to come off the active material layer when the active material layer is cut or a cut is made on the boundary between the active material layer and the core exposing portion. The material that comes off becomes a conductive contaminant that tends to cause internal short-circuiting in the positive electrode active material layer. A core exposing portion is provided between negative electrode active material layers and the cut is made in the core exposing portion so that conductive contaminants are not produced. Therefore, in the resulting negative electrode, a negative electrode core exposing portion 32a, 32b is formed on both sides of the negative electrode active material layer 31.

In this situation, a highly conductive positive electrode core and negative electrode core are arranged opposite each other. When a short circuit occurs between opposing core regions, the flow of current is significant and the battery is in danger of rupturing. Therefore, as shown in FIG. 4, a layer (positive electrode protecting layer) 23 less conductive than the positive electrode core is preferably provided in the positive electrode core exposing portion 22a contiguous with the positive electrode active material layer 21 in order to prevent a substantial flow of current. The positive electrode protecting layer 23 also functions as a layer for promoting the penetration of non-aqueous electrolyte into the positive electrode active material layer 21.

In other words, in the present embodiment, a non-aqueous electrolyte secondary battery with better liquid infusing properties than the first embodiment can be provided with higher productivity than in the first embodiment.

Here, the positive electrode protecting layer preferably contains inorganic particles and a binder. The inorganic particles can be conductive inorganic particles such as graphite particles and carbon particles, and insulating inorganic particles (insulating metal oxide particles) such as zirconia, alumina and titania. The binder can be an acrylonitrile-based binder or a fluorine-based binder.

When the positive electrode protecting layer contains conductive inorganic particles and an internal short circuit has occurred in a region opposite the core due to conductive contaminants, a flow of weak internal short circuit current can be continued so the battery can transition to a safe state. Conductive inorganic particles and insulating inorganic particles can be mixed together to control the conductivity.

When the inorganic particles are made of a material with a high contrast relative to the positive electrode core material, formation defects in the protecting layer can be detected using a visual inspection means. For example, when the positive electrode core is pure aluminum or an aluminum alloy, the use of graphite particles as the inorganic particles provides a high contrast.

The average particle size of the inorganic particles is preferably from 0.1 to 10 μm. From the standpoint of productivity and energy density, the width of the positive electrode protecting layer is preferably 10 to 50% of the width of the positive electrode core exposing portion. Also, from the standpoint of productivity, the thickness of the positive electrode protecting layer is preferably less than the thickness of the positive electrode active material layer, and more preferably greater than 20 μm and less than 80% of the thickness of the positive electrode active material layer.

The following is an explanation of the method used to produce the positive electrode protecting layer. As in the first embodiment, a dry electrode is produced for the positive electrode. This dry electrode is rolled using a roll press. Next, a positive electrode protective layer slurry is applied to the positive electrode core exposing portion 22a contiguous with the positive electrode active material layer 21 and dried to form a positive electrode protecting layer 23. The positive electrode protective layer slurry is prepared by mixing together 53 parts by mass alumina serving as the insulating inorganic particles, 2 parts by mass carbon serving as the conductive inorganic particles and colorant, 9 parts by mass polyvinylidene fluoride (PVDF) serving as the binder, and 36 parts by mass N-methyl-2-pyrrolidone serving as the solvent. Afterwards, the plate is cut to a predetermined size to complete the positive electrode 20.

### Additional Details

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

The negative electrode active material can be a carbon material such as natural graphite, carbon black, coke, glassy carbon, carbon fibers, or baked products of these. These carbon materials can be used alone or in mixtures of two or more.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

In addition to lithium bis(oxalato)borate and lithium difluorophosphate, one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)F₂, LiP(C₂O4)₃, LiP(C₂O₄)₂F₂, and LiP(C₂O₄)F₄. The total concentration of electrolyte salts in the non-aqueous electrolyte is preferably from 0.5 to 2.0 mol/L.

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide with high productivity a non-aqueous electrolyte secondary battery having a high capacity. Thus, industrial applicability is great.

### KEY TO THE DRAWINGS

1: Outer Can

2: Sealing Plate

5, 6: Electrode Terminals

10: Electrode Assembly

14: Positive Electrode Collector

15: Negative Electrode Collector

20: Positive Electrode

21: Positive Electrode Active Material Layer

22a: Positive Electrode Core Exposing Portion

23: Positive Electrode Protecting Layer

30: Negative Electrode

31: Negative Electrode Active Material Layer

32a, 32b: Negative Electrode Core Exposing Portions

What is claimed is:

1. A non-aqueous electrolyte secondary battery including a positive electrode and a non-aqueous electrolyte containing a non-aqueous solvent, the non-aqueous electrolyte secondary battery characterized in that the positive electrode has a positive electrode core and a positive electrode active material layer formed on the positive electrode core, the non-aqueous solvent includes 30 to 70 vol % ethylene carbonate at 25° C. and 1 atm, the non-aqueous electrolyte includes lithium bis(oxalato)borate, and the packing density of the positive electrode active material layer is from 2.0 to 2.8 g/ml.

2. The non-aqueous electrolyte secondary battery according to claim 1, wherein the non-aqueous electrolyte also includes lithium difluorophosphate.

3. The non-aqueous electrolyte secondary battery according to claim 1, wherein the battery capacity of the non-aqueous electrolyte secondary battery is 21 Ah or greater.

4. The non-aqueous electrolyte secondary battery according to claim 1, wherein the positive electrode has a positive electrode core exposing portion in which the positive electrode active material layer is not formed and in which the positive electrode core is exposed, and a positive electrode protecting layer containing insulating inorganic particles and conductive inorganic particles is formed in a region of the positive electrode core exposing portion contiguous with the positive electrode active material layer.
